(19) United States
(12) Patent Application Publication
(10) Pub. No.: US 2007/0183959 A1
(43) Pub. Date: Aug. 9, 2007

(54) Carbon nanostructures and process for the production of carbon-based nanotubes, nanofibres and nanostructures

(75) Inventors: Jean-Christophe Charlier, Surice (Phillipeville) (BE); Frederic Fabry, Le Cannet (FR); Gilles Flamant, Llo (FR); Laurent Fulcheri, Mouanx-Sartoux (FR); Jose Gonzalez, Juan Les Pins (FR); Eusebiu Grivei, La Hulpe (BE); Thomas M. Gruenberger, Jette (BE); Hanako Okuno, Louvain-La-Neuve (BE); Nicolas Probst, Bruxelles (BE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: Armines Association Pour la Recherche et le Development des Methodes et Processis Industriels, Paris (FR); Timcal SA, Bodio (CH)

(21) Appl. No.: 10/550,158

(22) PCT Filed: Mar. 22, 2004
(86) PCT No.: PCT/EP04/03000

§ 371 Date: Oct. 10, 2006

(30) Foreign Application Priority Data
Mar. 20, 2003 (DE) 103 12 494.2

(51) Int. Cl. D01F 9/12; C01B 31/00; B01J 21/18

(52) U.S. Cl. 423/447.1; 502/182; 502/183; 502/184; 502/185; 977/844; 204/173

(57) ABSTRACT

Continuous process for the production of carbon-based nanotubes, nanofibres and nanostructures, comprising the following steps: generating a plasma with electrical energy, introducing a carbon precursor and/or one or more catalysers and/or carrier plasma gas in a reaction zone of an airtight high temperature resistant vessel optionally having a thermal insulation lining, vaporizing the carbon precursor in the reaction zone at a very high temperature, preferably 4000° C. and higher, guiding the carrier plasma gas, the carbon precursor vaporized and the catalyser through a nozzle, whose diameter is narrowing in the direction of the plasma gas flow, guiding the carrier plasma gas, the carbon precursor vaporized and the catalyses into a quenching zone for nucleation, growing and quenching operating with flow conditions generated by aerodynamic and electromagnetic forces, so that no significant recirculation of feedstocks or products from the quenching zone into the reaction zone occurs, controlling the gas temperature in the quenching zone between about 4000° C. in the upper part of this zone and about 50° C. in the lower part of this zone and controlling the quenching velocity between 103 K/s and 106 K/s quenching and extracting carbon-based nanotubes, nanofibres and other nanostructures from the quenching zone, separating carbon-based nanotubes, nanofibres and nanostructures from other reaction products.

### FIELD OF THE INVENTION

The invention relates to a process for the economical and continuous production of carbon-based nanotubes, nanofibres and nanostructures. The invention also relates to novel carbon nanostructures.

### BRIEF DESCRIPTION OF THE PRIOR ART

Carbon fibres have long been known and many methods for their production have been developed, see for example M. S. Dresselhaus, G. Dresselhaus, K. Suglhara; I. L. Spain, and H. A. Goldberg, Graphite Fibers and Filaments, Springer-Verlag, new York (1988).

Short (micron) lengths of forms of fullerene fibres have recently been found on the end of graphite electrodes used to form a carbon arc, see T. W. Ebbesen and P. M. Ajayan, “Large Scale Synthesis of Carbon Nanotubes.” Nature Vol. 358, pp. 220-222 (1992), and M. S. Dresselhaus, “Down the Straight and Narrow,” Nature, Vol. 358, pp. 195-196, (16. Jul. 1992), and references therein. Carbon nanotubes (also referred to as carbon fibrils) are seamless tubes of graphite sheets with full fullerene caps which were first discovered as multi-layer concentric tubes or multi-wall carbon nanotubes and subsequently as single-wall carbon nanotubes in the presence of transition metal catalysts. Carbon nanotubes have shown promising applications including nano-scale electronic devices, high strength materials, electronic field emission, tips for scanning probe microscopy, gas storage.

Presently, there are four main approaches for synthesis of carbon nanotubes. These include the laser ablation of carbon (Thess, A. et al., Science 273, 483 (1996)), the electric arc discharge of graphite rod (Journet, C. et al., Nature 388, 756 (1997)), the chemical vapour deposition of hydrocarbons (Ivanov, V. et al., Chem. Phys. Lett. 223, 329 (1994); Li A. et al., Science 274, 1701 (1996)) and the solar method (Fields; Clark L et al., U.S. Pat. No. 6,077,401).

The production of multi-wall carbon nanotubes by catalytic hydrocarbon cracking is described in U.S. Pat. No. 5,578,543. The production of single-wall carbon nanotubes has been described by laser techniques (Rinzler, A. G. et al., Appl. Phys. A. 67, 29 (1998)), arc techniques (Haffner, J. H. et al., Chem. Phys. Lett. 296, 195 (1998)).

Unlike the laser, arc and solar techniques, carbon vapour deposition over transition metal catalysts has been found to create multi-wall carbon nanotubes as a main product instead of single-wall carbon nanotubes. However, there has been some success reported in producing single-wall carbon nanotubes from the catalytic hydrocarbon cracking process. Dai et al. (Dai, H. et al., Chem. Phys. Lett 260, 471 (1996)) demonstrate web-like single-wall carbon nanotubes resulting from decomposition of carbon monoxide (CO).

In PCT/EP94/00321 a process for the conversion of carbon in a plasma gas is described. Fullerenes can be produced by this process.

The availability of these carbon nanotubes in quantities necessary for practical technology is problematic. Large scale processes for the production of high quality carbon nanotubes are needed. Furthermore, carbon nanostructures with closely reproducible shapes and sizes constitute another object of this invention

### DETAILED DESCRIPTION OF THE INVENTION

The invention and improvement we will describe now presents the improvements of the process necessary for the production of carbon-based nanotubes, nanofibres and novel nanostructures. According to the present invention, a method for producing carbon nanotubes is provided which avoids the defects and disadvantages of the prior art.

The invention is defined in the independent claims. Preferred embodiments are shown in the dependent claims.

In accordance with a first embodiment of the invention, there is provided a continuous process for the production of carbon-based nanotubes, nanofibres and nanostructures. This process involves the following steps preferably in that sequence.

A plasma is generated with electrical energy.

A carbon precursor and/or one or more catalysers or catalysts and/or a carrier plasma gas is introduced into a reaction zone. This reaction zone is in an airtight high temperature resistant vessel optionally, in some embodiments preferably having a thermal insulation lining.

The carbon precursor is vaporized at very high temperatures in this vessel, preferably at a temperature of 4000° C. and higher.

The carrier plasma gas, the vaporized carbon precursor and the catalyser are guided through a nozzle, whose diameter is narrowing in the direction of the plasma gas flow.

The carrier plasma gas, the carbon precursor vaporized and the catalyser are guided through the nozzle into a quenching zone for nucleation, growing and quenching. This quenching zone is operated with flow conditions generated by aerodynamic and electromagnetic forces, so that no significant recirculation of feedstocks or products from the quenching zone into the reaction zone occurs.

The gas temperature in the quenching zone is controlled between about 4000° C. in the upper part of this zone and about 50° C. in the lower part of this zone.

The carbon-based nanotubes, nanofibres and other nanostructures are extracted following the quenching. The quenching velocity is preferably controlled between 10³ K/s and 10⁶ K/s (K/s degrees Kelvin per second).

Finally, the carbon-based nanotubes, nanofibres and nanostructures are separated from other reaction products.

The plasma is generated in the preferred embodiment of this invention by directing a plasma gas through an electric arc, preferably a compound arc created by at least two, preferably three electrodes.

Further preferred features of the claimed process which can be used individually or in any combination encompass the following:
The plasma is generated by electrodes consisting of graphite.
The arc is generated by connecting an AC power source to electrodes, preferably one where the current frequency lies between 50 Hz and 10 kHz.
The absolute pressure in the reactor lies between 0.1 bar and 30 bar.
The nozzle used consists of graphite at its inner surface.
The nozzle is formed as a continuous or stepped cone.
The nozzle used has a downstream end which abruptly expands from the nozzle throat.
The carbon precursor used is a solid carbon material, comprising one or more of the following materials: Carbon black, acetylene black, thermal black, graphite, coke, plasma carbon nanostructures, pyrolitic carbon, carbon aerogel, activated carbon or any other solid carbon material.
The carbon precursor used is a hydrocarbon preferably consisting of one or more of the following: methane, ethane, ethylene, acetylene, propane, propylene, heavy oil, waste oil, pyrolysis fuel oil or any other liquid carbon material.
Solid catalyst is used consisting of one or more of the following materials: Ni, Co, Y, La, Gd, B, Fe, Cu is introduced in the reaction zone.
A liquid catalyst is used consisting of one or more of the following materials: Ni, Co, Y, La, Gd, B, Fe, Cu in a liquid suspension or as a corresponding or ganometallic compound which is preferably added to the carbon precursor and/or to the carrier gas.
A gas carrying a carbon precursor and/or carrying catalyst and/or to produce the plasma and/or to quench the products and/or to extract the products comprises or consists of one or more of the following gases: Hydrogen, nitrogen, argon, carbon monoxide, helium or any other pure gas without carbon affinity and which is preferably oxygen free.
The gas temperature in the reaction zone is higher than 4000° C.
The gas temperature in the quenching zone is controlled between 4000° C. in the upper part of this zone and 50° C. in the lower part of this zone.
The carrier plasma gas flow rate is adjusted, depending on the nature of the carrier plasma gas and the electrical power, between 0.001 Nm³/h to 0.3 Nm³/h per kW of electric power used in the plasma arc.
The quenching gas flow rate is adjusted, depending on the nature of the quenching gas, between 1 Nm³/h and 10 000 Nm³/h.
A portion of the off-gas from the reaction is recycled as at least a portion of the gas for generating the plasma.
A portion of the off-gas from the reaction is recycled as at least a portion of the gas for generating the quenching gas.
A carbon precursor is injected through at least one injector, preferably through two to five injectors.
A carbon precursor is injected into the reaction zone.
A carbon precursor is injected with a tangential and/or with a radial and/or with an axial flow component into the reaction zone.
A catalyst is injected into the reaction zone and/or the quenching zone.
The process is carried out in the total absence of oxygen or in the presence of a small quantity of oxygen, preferably at an atomic ratio oxygen/carbon of less than 1/1000.
If the plasma gas is carbon monoxide, the process is carried out in the presence of oxygen with a maximum atomic ratio oxygen/carbon of less than 1001/1000 in the plasma gas.

One or more of the following products is recovered.
i. Carbon black
ii. Fullerenes
iii. Single wall nanotubes
iv. Multi-wall nanotubes
v. Carbon fibres
vi. Carbon nanostructures
vii. Catalyst

A yet further embodiment of this invention is a reactor to carry out the process of this invention. This reactor comprises in open flow communication
A head section comprising
   i. at least two, preferably three electrodes
   ii. a carbon precursor supply and/or a catalyst supply and/or a gas supply.
At least one injector for carbon precursor and/or catalyst injection into the reaction zone,
a reaction zone designed in size, shape and choice of materials so that the gas temperature during operation is 4000° C. or higher, preferably is well above 4000° C.,
a quenching zone designed in size, shape and choice of materials so that the gas temperature is controllable between 4000° C. in the upper part of this zone and 50° C. in the lower part of this zone,
a nozzle shaped choke, narrowing the open flow communication direction between the reaction zone and the quenching zone.

The electrodes are connected to means for creating an electric arc between the electrodes when a sufficient electric power is supplied. Thereby, an arc zone is generated into which the gas from the gas supply can be fed to generate a plasma gas and in which the carbon precursor can be heated at a vaporization temperature of 4000° C. and higher, preferably well above 4000° C.

The reactor in its preferred structure has substantially an interior cylindrical shape. Typically and preferably the reactor at the surfaces exposed to high temperatures is from graphite or respectively graphite containing high temperature resistant material. The reactor in the preferred embodiment comprises a chamber with a height between 0.5 and 5 m and a diameter between 5 and 150 cm.

In a more specific embodiment the reactor of this invention comprises temperature control means for the quench zone. These temperature control means are particularly selected from thermal insulating lining, fluid flow, preferably water flow, indirect heat exchange means and flow and/or temperature controlled quench gas injection means.

The nozzle mentioned is in the preferred embodiment a tapering choke followed by an abruptly expanding section.

In accordance with a yet further embodiment of the invention, there are provided novel carbon nanostructures. These carbon nanostructures have the shape of a linear, i.e. essentially un-branched chain of connected and substantially identical sections of beads, namely spheres or bulb-like units or trumpet shaped units. These trumpet shaped units form carbon nanostructures the SEM or TEM of which resembles a necklace-like structure. These novel carbon nanostructures preferably have diameters of the spherical portions of the spheres or bulb-like units or respectively of the large end of the trumpet shaped units in the range of 100 to 200 nm. The shapes mentioned are those visible in TEM at very large magnification and in HRTEM.

The carbon nanostructures of this embodiment of the invention are connected to fairly long chains and as a rule all of these chains have at least 5 beads connected to each other. The structures will preferably have 20 to 50 beads in one chain.

In yet another variation of the carbon nanostructures of this invention, these are filled or at least substantially filled with catalyst metal, more specifically with nickel or nickel/cobalt. These metal filled nanostructures form an excellent source of catalyst for the process to produce such nanostructures. Separating these structures from the product of the quenching zone and introducing the structures back into the reaction zone is a recirculation of the catalytic material in an encapsulated and finely divided form. In the reaction zone itself, the carbon and the metal are both evaporated.

In one embodiment the bulb-like structures of the inventive carbon nanostructures are connected together at the neck portion.

Preferred applications of these new nanostructures:

The present carbon nanotubes are different in shape when compared to the convential multi-wall nanotubes which exhibit a perfect stacking of graphitic cylinders. In that sense, the described novel structures, in particular such bamboo-shaped structures have advantages e.g. in gas storage (easier way to store hydrogen between the graphitic cones), and also for field emission properties, which are known to depend on the topology at the nanotube tip apex, and more specifically to the conical angle (related to the number of pentagons present at the tip apex).

On the other hand, the necklace-like nano-structures have never been reported before, and they allow in a preferred embodiment the combination in composite materials both when incorporated into the matrix in an oriented or in a nonoriented way. A preferred embodiment of the invention is thus a composite comprising the necklace-like nano-structures in a matrix, preferably a polymer matrix. Such nano-objects increase the interaction between the nano-fiber and the host material, as compared to conventional tubes. They increase the mechanical properties of composite materials. As the nano-spheres are intrinsically connected, and can contain metal catalyst, these nano-necklaces can also be used in nanoelectronics.

The invention will be further illustrated, preferred details and combination of details of the invention shown in conjunction with examples and the drawing in which:

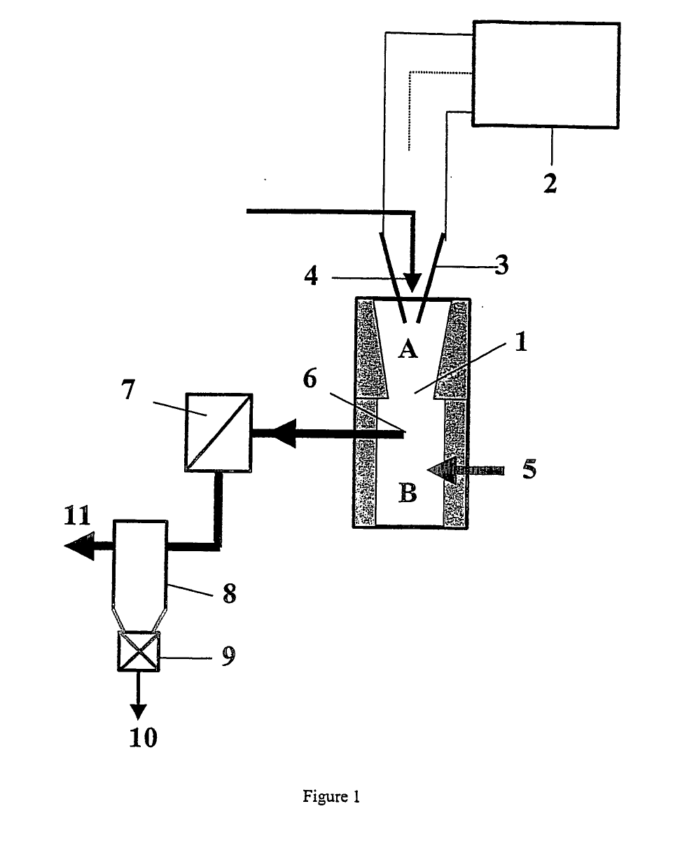

FIG. 1 shows a schematic view of a facility or an apparatus for carrying out the process of the invention.

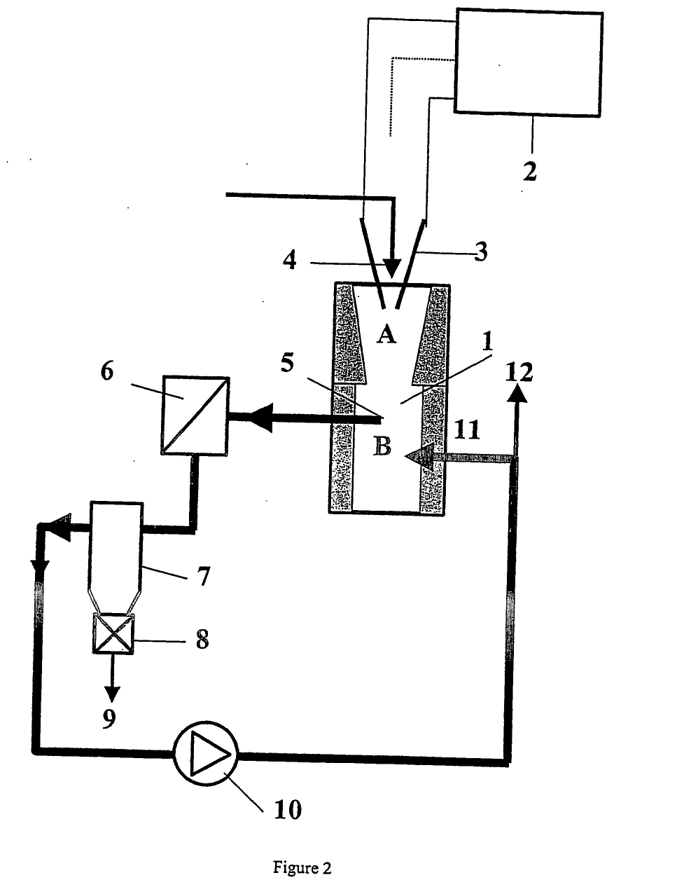

FIG. 2 shows a variation of an apparatus of FIG. 1.

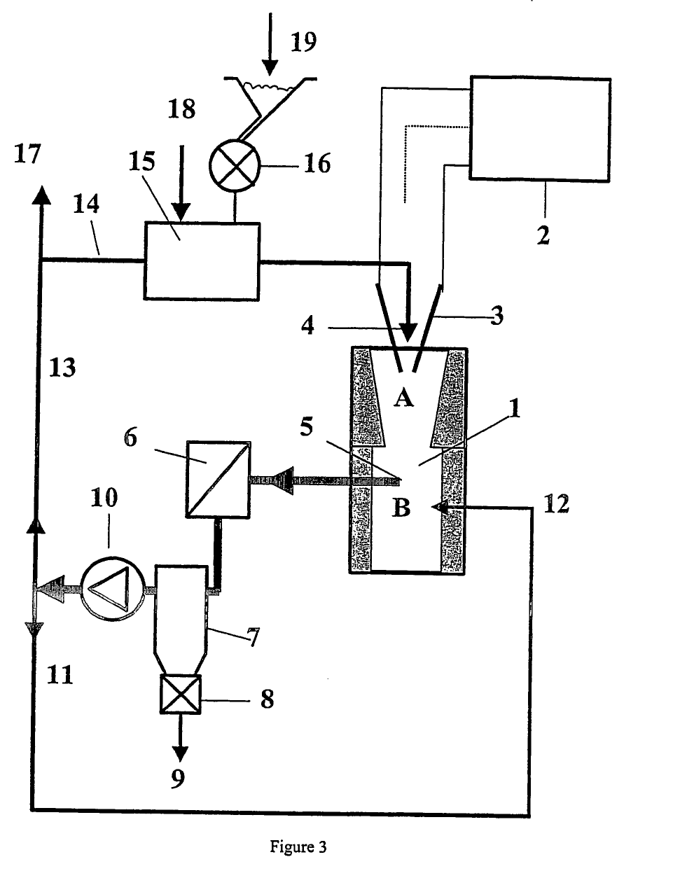

FIG. 3 shows a yet further variation with some added specific features of an apparatus in accordance with the invention.

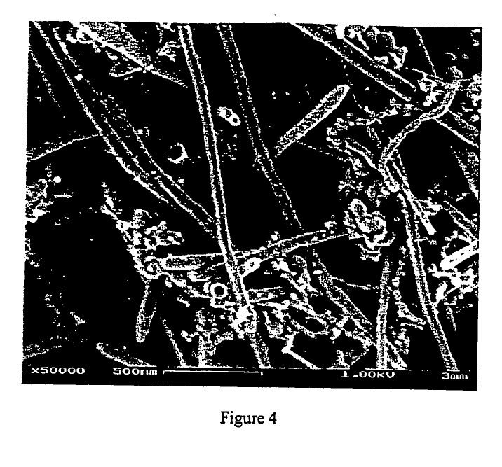

FIG. 4 shows a SEM picture of open multi-wall nanotubes.

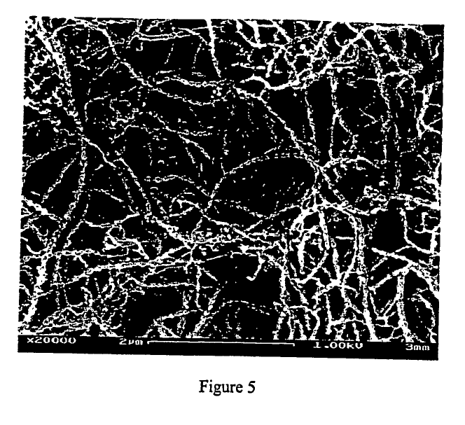

FIG. 5 shows a SEM image of a spaghetti-like arrangement of multi-wall and necklace-shaped nanotubes.

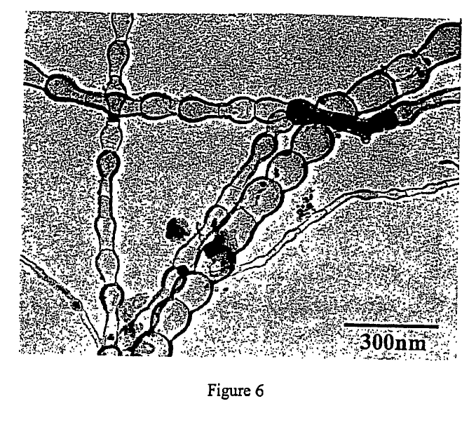

FIG. 6 shows a TEM picture of necklace shaped carbon nanostructures in accordance with the invention.

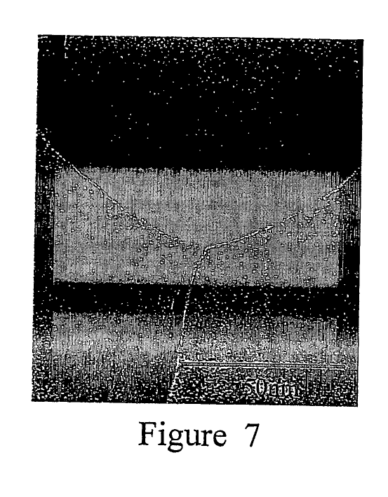

FIG. 7 shows a HRTEM picture of carbon necklace structures of bulb-like beads.

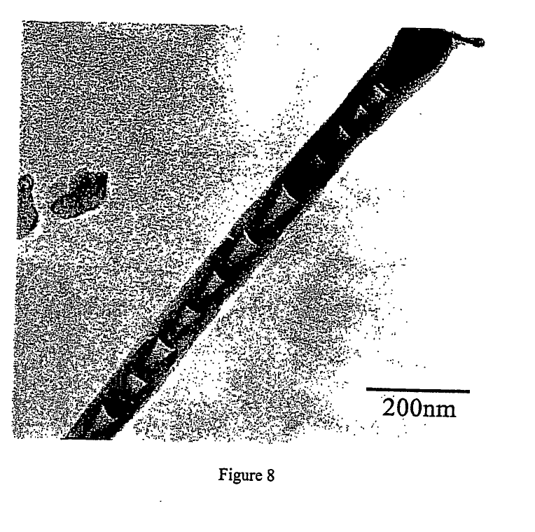

FIG. 8 shows a TEM picture of carbon nanotubes having a bamboo-like structure.

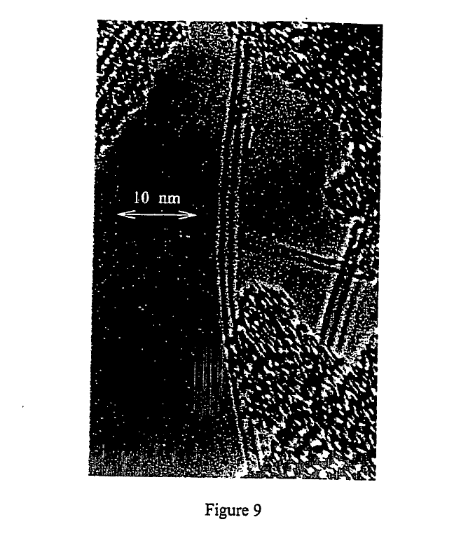

FIG. 9 shows a HRTEM picture of single-wall nanotubes.

The reactor 1 is designed in a way that it consists of two different but adjacent zones. Zone A, for the vaporization of the precursor (carbonaceous products and catalytic products), is maintained at a very high temperature due to the action of a thermal plasma and an appropriate thermal insulation. Zone B, for the nucleation and maturation of the carbon-based nanostructures, is kept between 4000° C. in the upper part and less than 50° C. in the lower part due to an adequate thermal insulation.

In zone A, the geometry of the internal fittings has the shape of a venturi which is specifically designed to assure the complete vaporization of the precursors. Each of the three electrodes 3, of which only two are shown in FIG. 1, is connected to one of the three phases of an electric three-phase generator and supplied with alternative current. After activation of the electric generator and the establishment of the plasma by the contact of the three electrodes, the electrodes are automatically drawn apart and a plasma flow is established in zone A of the reactor, which allows the complete vaporization of the precursor. Once the plasma is established, the control of the electrodes to compensate for their erosion is effectuated automatically. Together with a carrier plasma gas, the carbonaceous product and the catalytic product are continuously injected into zone A of the reactor, for example in 4.

The electric power source is of the type “three-phase”, whereby the frequency of the supply can vary between 50 Hz and 10 kHz. Each of the three phases of the electric source is connected to one of the three electrodes of the reactor. The inventors discovered that an increase of the frequency of the electric supply beyond 50 Hz, which can range from 50 Hz to 10 kHz, achieves particular advantages. This increase of the frequency allows on the one hand an increase in the stability of the plasma, and on the other hand a very advantageous increase in the homogeneity of the mixture of the plasma gas with the carbonaceous product vaporized and the catalyst product due to important turbulence phenomena in the flow field of zone A. This turbulence is caused by the combined effects of arc rotation between the three electrodes successively changing from anode and cathode with current frequency and the electromagnetic forces induced by the current in the electrodes and the arcs themselves.

In zone B of the reactor, the zone of the nucleation and growing of the carbon-based nanostructures, the temperature of the flow in maintained between 4000° C. in the upper part and less than 50° C. in the lower part due to an adequate thermal insulation. The absolute pressure in zones A and B of the reactor can be between 100 mbar and 30 bar. Into this zone, a certain quantity of cold gas is injected in 5, allowing the quenching of the aerosols and their extraction from the reactor in 6 by means of an extraction system cooled by a liquid, a gas or any other means of refrigeration known within the state of the art. Afterwards, the aerosol is transported to a heat exchanger in 7 where it is cooled down further to a stabilization temperature of the envisaged carbon-based nanostructures and finally passes through a separation system in 8 where the carbon-based nanostructures are separated from the gas phase. Eventually, the carbon-based nanostructures are taken out in 10 by means of an airtight valve represented in 9 and the gas is vented in 11.

In accordance with a preferred embodiment of the invention, full control of the extraction conditions and the quenching rate is foreseen thereby controlling the quality of the nanostructures obtained. Both the temperature at which the aerosol is extracted and the quenching speed of the aerosol are preferably controlled to ensure high quality products.

Preferred control approaches include the following. The temperature at which the extraction is effectuated and the residence time for product maturation is controlled by the variation of the axial position of the injection point of cold gas in 5 and the extraction point in 6 in zone B. The quenching velocity rate is controlled by a variation in the nature and the flow rate of cold gas injected in 5, by the effectiveness of the extraction system cooled in 6 and by the effectiveness of the heat exchanger in 7.

In a preferred embodiment shown in FIG. 2, zone B of the reactor is modified by the installation of a recirculation system for the quenching gas flow as described hereafter. In zone B of the reactor where the temperature is maintained between 4000° C. in the upper part and less than 50° C. in the lower part, a device cooled by a liquid, a gas or any other means of refrigeration known within the state of the art is introduced in 5, which allows the extraction of the aerosols in 6 and the transport to a separation system in 7. The temperature of the zone of which the extraction is effectuated, is controlled by the variation of the axial position of the injection point of cold gas in 11 and the extraction point in 5. The quenching rate is controlled by a variation in the flow rate of cold gas injected into zone B in 11 by means of a blower 10, by the effectiveness of the extraction system cooled in 5 and by the effectiveness of the heat exchanger in 6. Therefore, the gas flow rate in the recirculation circuit is independent of the initial carrier gas flow entering in 4. The aerosol is transported to a heat exchanger in 6 where it is cooled down further to a stabilization temperature of the envisaged carbon-based nanostructures and finally passes through a separation system in 7 where the carbon-based nanostructures are separated from the gas phase. Eventually, the carbon-based nanostructures are taken out in 9 by means of a valve 8. The excess gas flow equivalent of the amount of gas entering in 4 is vented in 12.

In a preferred embodiment shown in FIG. 3, zone B of the reactor is modified by the installation of a recirculation system for the quenching gas flow and the carrier plasma gas supplying the plasma itself as described hereafter. In zone B of the reactor where the temperature is maintained between 4000° C. in the upper part and less than 50° C. in the lower part, a device cooled by a liquid, a gas or any other means of refrigeration is introduced in 5, which allows the extraction of the aerosols in 6 and the transport to a separation system 7. The temperature of the zone of which the extraction is effectuated, is controlled by the variation of the axial position of the injection point of cold gas in 12 and the extraction point 5. The quenching rate is controlled by a variation in the flow rate of cold gas injected into zone B in 12 by means of a blower 10, by the effectiveness of the extraction via extraction point 5 and by the effectiveness of the heat exchanger 6. Therefore, the gas flow rate in the recirculation circuit is independent of the initial carrier gas flow entering in 18. The aerosol is transported to a heat exchanger 6 where it is cooled down further to a stabilization temperature of the envisaged carbon-based nanostructures and finally passes through a separation system 7 where the carbon-based nanostructures are separated from the gas phase. Eventually, the carbon-based nanostructures are taken out in 9 by means of a valve 8. A part of the gas vented in 13 is used as carrier plasma gas in 14. A feeding system 15 with a gas feeding 18 and a valve 16 allows the continuous feeding of solid carbon material in 4. The excess gas flow equivalent of the amount of gas entering in 18 is vented in 17.

The raw material used as a precursor consist of one or a combination of the following elements: A carbonaceous product, a catalytic product and/or a gaseous product. The product used as carbonaceous product can be of solid, liquid or gaseous nature.

In the case of solid carbonaceous materials, different types of products can be utilized, for example: Finely milled graphite, acetylene black, carbon black degassed, milled pyrolitic carbon, activated carbon, pyrolized carbon aerogels, plasma carbon nanostructures. The carbon content of the utilized carbonaceous material should be as high as possible, preferably higher than 99 weight %. The average particle size of the carbonaceous materials should be as small as possible, preferably smaller than 10 μm in diameter, to ensure its complete vaporization when passing through the plasma.

In the case of liquid and gaseous carbon precursors any kind of hydrocarbon can be considered.

The catalytic material associated with the carbonaceous material can consist of one or a mixture of elements well known for their catalytic characteristics in carbon nanotubes synthesis, such as: Ni, Co, Y, La, Gd, B, Fe, Cu. The catalytic materials are introduced in zone A (preferred) or zone B of the reactor, either in form of a powder mixed with the carbon material, or in form of a deposit on the carbon material, or in form of a solid whereby the morphology can vary corresponding to the hydrodynamic prevalent in the reactor, or in the form of a liquid. The mass ratio of catalyser to carbon can vary between 0.1% and 50%.

In the case of liquid carbon precursors, the catalytic elements are preferably mixed with the liquid.

In the case of gaseous carbon precursors, the catalytic elements are preferably introduced in form of a powder.

In the case of solid carbon precursors, the catalytic elements are preferably introduced in form of a deposit on the carbon material.

The plasma gas is preferably a pure gas: Helium, argon, nitrogen or a mixture of one of these gases with the following gases: Helium, argon, nitrogen, carbon monoxide, hydrogen.

The quenching gas can be identical to the plasma gas or consist of any kind of gas mixture.

In the following examples further preferred features, feature combinations and embodiments of this invention are illustrated.

The examples were carried out in a reactor set-up substantially as shown in FIGS. 1 and 2.

### EXAMPLE 1

The reactor set-up, described in FIG. 1, consists of a cylindrical reactor of a height of 2 meters in stainless steel with water-cooled walls and 400 mm internal diameter. The upper part of the reactor is fitted with thermal insulation cone-shaped in graphite of 500 mm height and an internal diameter between 150 and 80 mm. Three electrodes in graphite of 17 mm diameter are positioned through the head of the reactor by a sliding device system electrically insulated. A central injector of 4 mm internal diameter allows the introduction of the precursor by means of a carrier plasma gas in the upper part of the reactor. A plasma power supply, employing a three phase electricity source up to 666 Hz with a maximum power of 263 kVA, a RMS current range of up to 600 A and a RMS voltage range of up to 500 V, was used to supply electricity to the three graphite electrodes, their tips being arranged in the shape of an inversed pyramid.

The carrier plasma gas is helium and the precursor is carbon black with a deposit of nickel-cobalt corresponding to a weight ratio in relation to the carbon of 2,5 weight % for the nickel and 3 weight % for the cobalt. The gas for the quenching is helium.

The following table gives the main operating conditions.

| | | |
|---|---|---|
| Nature of carrier plasma gas - flow rate | Helium - 3 | Nm³/h |
| Precursor flow-rate | 850 | g/h |
| RMS Voltage | 100 | V |
| RMS Current | 400 | A |
| Frequency | 666 | Hz |
| Active power | 61 | kW |
| Average temperature in the injection zone | 5200° | C. |
| Average temperature in the extraction zone | 3500° | C. |
| Quenching gas flow-rate | 30 | Nm³/h |
| Quenching velocity (3500° C.-500° C.) | 10⁶ | K/s |

More than 98% of the injected precursor mass was removed from the filter. The recovered product is composed of: 40% of Single Walled Carbon Nanotubes, 5.6% of fullerenes whereby 76% of C60 and 24% of C70, 5% of Multi Walled Carbon Nanotubes, about 20% of fullerene soots, about 30% of undefined carbon nanostructures with catalyst particles. Quantitative and qualitative measurements of carbon nanostructures are achieved using Scanning Electronic Microscopy and Transmission Electronic Microscopy. Quantitative and qualitative measurements of the fullerenes (C60 and C70) are achieved using UV—visible spectroscopy at the wavelengths 330 nm and 470 nm after Soxhlet-extraction with toluene.

### EXAMPLE 2

One operates in similar conditions to example 1 but according to the configuration corresponding to FIG. 2. Carrier plasma gas is nitrogen at a flow-rate of 2 Nm³/h. The quenching gas is nitrogen at a flow-rate of 50 Nm³/h. Electrical conditions are 350 A and 200 V. In these conditions necklace shaped carbon nanostructures are produced in very high concentration.

### EXAMPLE 3

One operates in similar conditions to example 1 but according to the configuration corresponding to FIG. 2. Carrier plasma gas is helium at a flow rate of 3 Nm³/h. The quenching gas is a mixture of nitrogen/helium at a flow rate of 50 Nm³/h. Electrical conditions are those of example 1. The precursor is ethylene (C₂H₄) mixed with nickel-cobalt powders corresponding to a weight ratio in relation to the carbon of 3 weight % for the nickel and 2 weight % for the cobalt. The recovered product is composed of: 55 weight % of single walled carbon nanotubes, 13 weight % of carbon nanofibres and multi walled carbon nanotubes, the rest of undefined carbon nanostructures with catalyst particles.

The carbon nanostructures of FIG. 4-9 illustrate embodiments of the invention. The preferred carbon nanostructures of this invention have the structure of a linear chain of connected, substantially identical sections of beads, namely spheres or bulb-like units or trumpet shaped units, preferably having a diameter of the spheres of the spherical section of the bulb-like units or respectively the large diameter of the trumpet shaped section in the range of 100 to 200 nanometres. All spheres or bulb-units exhibit nearly the same diameter. These periodic graphitic nano-fibers are characterized by a repetition of multi-wall carbon spheres (‘necklace’-like structure), connected along one direction, and containing frequently a metal particle encapsulated in their structure. The periodicity of these nanostructures relates them to the bamboo nanotubes, but they clearly differ by their periodic necklace-like structure and the presence of these metal inclusions.

1-21. (canceled)

22. A process for producing at least one carbon-based structure selected from nanotubes, nanofibers and nanostructures, comprising the steps of:
a) generating a plasma with electrical energy;
b) introducing a carbon precursor and optionally one or more catalysts and optionally a carrier plasma gas in a reaction zone of a high temperature resistant vessel;
c) vaporizing the carbon precursor in the reaction zone at a very high temperature forming a vaporized carbon precursor;
d) guiding at least a fraction of the vaporized carbon precursor through an opening in a nozzle having an inlet and an outlet wherein the opening narrows toward the outlet;
e) guiding at least a fraction of the vaporized carbon precursor into a quenching zone for nucleation wherein the quenching zone has an upper part and a lower part;
f) generating flow conditions by aerodynamic or electromagnetic forces to reduce flow of the carbon precursor, the vaporized carbon precursor, the one or more catalysts, and the carrier plasma gas from the quenching zone to the reaction zone;
g) controlling the temperature of the upper part of the quenching zone at the very high temperature and the lower part of the quenching zone at a lower temperature to provide a quenching velocity between 10³ K/s and 10⁶ K/s;
h) quenching the fraction of vaporized carbon precursor guided into the quenching zone;
i) extracting at least one carbon-based structure from the quenching zone where the at least one carbon-based structure is selected from nanotubes, nanofibers, and nanostructures; and
j) separating at least one carbon-based structure from at least one other reaction product.

23. The process of claim 22, wherein the step of generating the plasma with electrical energy comprises directing a carrier plasma gas through an electric arc formed between two or more electrodes.

24. The process of claim 22, wherein at least one characteristic of the process is chosen from;
a) the plasma is generated by electrodes consisting of graphite,
b) the carrier plasma gas is directed through an electric arc formed between two or more electrodes connected to an AC power source optionally having a current frequency between 50 Hz and 10 kHZ,
c) the reaction zone is subjected to an absolute pressure between 0.1 bar and 30 bar,
d) the opening in the nozzle has a surface consisting of graphite;
e) the nozzle comprises a continuous or stepped cone;
f) the opening in the nozzle abruptly expands toward the outlet;
g) the carbon precursor is a solid carbon material;
h) the carbon precursor is a hydrocarbon;
i) the catalyst is a solid catalyst;
j) the catalyst is a liquid catalyst;
k) the catalyst is one or more of Ni, Co, Y, La, Gd, B, Fe, and Cu in solid form, in liquid suspension or as an organometallic compound;
l) the catalyst is added to the carbon precursor;
m) the catalyst is added to the carrier gas;
n) the carrier plasma gas includes one or more of hydrogen, nitrogen, argon, carbon monoxide, helium or other gas without carbon affinity;
o) the carrier plasma gas is used to carry one or more of the carbon precursor and the catalyst;
p) a quenching gas is provided to the quenching zone wherein the quenching gas is chosen from hydrogen, nitrogen, argon, carbon monoxide, helium or other gas without carbon affinity;
q) the step of extracting the at least one carbon-based structure from the quenching zone comprises introducing an extracting gas to the quenching zone wherein the extracting gas is chosen from hydrogen, nitrogen, argon, carbon monoxide, helium or other gas without carbon affinity;
r) the gas temperature in the reaction zone is higher than 4000° C.;
s) the gas temperature in the quenching zone is between 4000° C. in the upper part of this zone and 50° C. in the lower part of this zone;
t) the flow of carrier plasma gas is adjusted, depending on the nature of the quenching gas, to provide between 0.001 Nm3/h to 0.3 Nm3/h per kW of electric power used in the plasma arc;
u) the quenching gas flow rate is adjusted, depending on the nature of the quenching gas, between 1 Nm3/h and 10 000 Nm3/h;
v) a portion of an off-gas from a reaction that produces at least one of the carbon-based structures is recycled as at least a portion of the gas for generating the plasma;
w) a portion of the off-gas from the reaction is recycled as at least a portion of the quenching gas;
x) the carbon precursor is introduced to the reaction zone by injecting the carbon precursor through at least one injector and optionally through two to five injectors;
y) the carbon precursor is injected into the reaction zone;
z) the carbon precursor is injected into the reaction zone with a flow component chosen from tangential, radial and axial;
aa) the process is carried out in an environment chosen from an environment with an absence of oxygen, an environment with a small quantity of oxygen, and an environment with an atomic ratio oxygen/carbon of less than 1/1000;
bb) the plasma gas is carbon monoxide and the process is carried out in the presence of oxygen with a maximum atomic ratio oxygen/carbon of less than 1001/1000 in the plasma gas;
cc) the process results in recovery of a product chosen from carbon black, fullerenes, single wall nanotubes, multi-wall nanotubes, carbon fibers, carbon nanostructures, and catalyst.

25. A reactor for producing carbon-based nanotubes, nanofibers and nanostructures comprising:
a) a head section comprising at least two electrodes; and
optionally comprising at least one supply chosen from a carbon precursor supply, a catalyst supply, and a gas supply;
b) a reaction zone characterized by having at least some gas temperatures during operation of 4000° C. or higher;
c) at least one injector for injecting into the reaction zone an injected material chosen from a carbon precursor and a catalyst,
d) a quenching zone where the gas temperature is controllable between 4000° C. in the upper part of this zone and 50° C. in the lower part of this zone, wherein the quenching zone is in fluid communication with the reaction zone; and
e) a nozzle shaped choke, narrowing the open flow communication between the reaction zone and the quenching zone, wherein the nozzle shaped choke comprises a nozzle having an opening.

26. The reactor of claim 25, wherein the reactor is characterized by having a substantially cylindrically shaped interior.

27. The reactor of claim 25, comprising a chamber with a height between 0.5 and 5 m and a diameter between 5 and 150 cm.

28. The reactor of claim 25, wherein surfaces subject to high temperature during operation of the reactor comprise graphite and optionally additional high temperature resistant material.

29. The reactor of claim 28, further comprising a chamber with a height between 0.5 and 5 m and a diameter between 5 and 150 cm.

30. The reactor of claim 25, further comprising a temperature control means for the quenching zone chosen from thermal insulating lining, fluid flow, indirect heat exchange means, flow controlled quench gas injection means, and temperature controlled quench gas injection means.

31. The reactor of claim 25, wherein the nozzle shaped choke is a tapering choke followed by an abruptly expanding section.

32. A carbon nanostructure comprising:
a linear chain structure characterized by connected, substantially identical beads, wherein the beads are selected from spheres, bulb-like units and trumpet shaped units.

33. The carbon nanostructure of claim 32, wherein the diameter of the spheres of the spherical section of the bulb-like units or respectively the large diameter of the trumpet shaped section are between 100 to 200 nanometers.

34. The carbon nanostructure of claim 33, wherein the diameter of the spheres or bulb-units are similar.

35. The carbon nanostructures of claim 32, comprising:
periodic graphitic nano-fibers characterized by a repetition of multi-wall carbon spheres connected along one direction wherein at least two or more of the multi-wall carbon spheres contain a metal particle.

36. The carbon nanostructures of claim 32, wherein at least 5 beads are connected in one chain.

37. The carbon nanostructures of claim 36, wherein 20 to 50 beads are connected in one chain.

38. The carbon nanostructures of claim 32, wherein one or more of the beads further comprises a catalyst.

39. The carbon nanostructures of claim 38, wherein the catalyst comprises a ferromagnetic metal catalyst.

40. The carbon nanostructures of claim 39, wherein the ferromagnetic metal catalyst comprises a metal atom chosen from nickel and cobalt.

41. The carbon nanostructures of claim 32, wherein the beads are bulb-like units or bell-like units connected to each other by external graphitic cylindrical layers.

42. A carbon nanotube comprising:
a multi-wall structure, wherein at least a portion of the multi-wall structure is formed by at least several stacked nanoconical structures.

43. The carbon nanotube of claim 42, wherein the nanotube further comprises:
a closed end conical tip apex and an opposite end, wherein the opposite end can be open or filled with a metal nanoparticle.

44. The carbon nanotube of claim 43, wherein the nanotube has an external diameter of about 100 nm to about 120 nm and a set of discontinuous conical cavities.

45. A structure comprising:
one or more carbon nanostructures or carbon nanotubes arranged in a random form.

46. A carbon nanostructure comprising:
single-walled nanostructures having at least one characteristic chosen from (i) one or both ends being open, (ii) one layer having a diameter between about 9.8 nm and about 2 nm, and (iii) length of any tubes is a few microns.

47. A carbon nanostructure comprising:
a shape substantially similar to a nanostructure shape shown in one or more of FIGS. 4-9.

48. A composite comprising:
a) a polymer matrix; and
b) carbon nanostructures having a linear chain structure characterized by connected, substantially identical beads, wherein the beads are selected from spheres, bulb-like units or trumpet shaped units.

49. The composite of claim 48, wherein the polymer is selected from the group consisting of polyethylene, polypropylene, polyamide, polycarbonate, polyphenylenesulfide, and polyester.
